(19) United States
(12) Patent Application Publication
(10) Pub. No.: US 2026/0004968 A1
(43) Pub. Date: Jan. 1, 2026

(54) TRANSFORMER AND POWER CONVERTER

(71) Applicant: LITE-ON TECHNOLOGY CORPORATION, TAIPEI CITY (TW)

(72) Inventors: Kai-De CHEN, TAIPEI CITY (TW); Yong-Long SYU, TAIPEI CITY (TW); Chen CHEN, TAIPEI CITY (TW)

(21) Appl. No.: 19/074,828

(22) Filed: Mar. 10, 2025

Related U.S. Application Data
(60) Provisional application No. 63/665,507, filed on Jun. 28, 2024.

(30) Foreign Application Priority Data
Feb. 10, 2025 (TW) 114104851

(51) Int. Cl. H01F 27/40; H01F 27/28

(52) U.S. Cl. CPC H01F 27/40; H01F 27/28

(57) ABSTRACT

A transformer includes a primary winding, a secondary winding, an external capacitor, and a compensation winding. The primary winding has a first end and a second end, which are respectively connected to the first potential point and the second potential point of a primary side circuit. The secondary winding has a third end and a fourth end, which are respectively connected to the third potential point and the fourth potential point of a secondary side circuit. The compensation winding has a fifth end and a sixth end, wherein one is connected to the first potential point and the other is connected to the third potential point via the external capacitor. The compensation winding is arranged between the primary winding and the secondary winding. The potential induced by the compensation winding is equal to that induced by the secondary winding. Also, a power converter using the transformer is provided.

### CROSS REFERENCE TO RELATED APPLICATIONS

This application claims the benefit of U.S. Provisional Application No. 63/665,507 filed Jun. 28, 2024, the entirety of which is incorporated by reference herein.

This Application claims priority of Taiwan Patent Application No. 114104851, filed on Feb. 10, 2025, the entirety of which is incorporated by reference herein.

### BACKGROUND OF THE INVENTION

### Field of the Invention

The present invention relates to a transformer and power converter, and in particular it relates to a transformer and a power converter using the same capable of suppressing electromagnetic interference and noise.

### Description of the Related Art

The switch mode power supply (SMPS) type of power converter is configured to convert an input voltage into a voltage or current based on the requirements of the user. The input of a switch mode power supply may be a direct current (DC) power source, or an alternating current (AC) power source (for example, utility power). A switch mode power supply mostly outputs DC power to electronic appliances, such as personal computers, servers, and mobile devices. A switch mode power supply converts the voltage and current between the power source and the electronic appliances.

Although the switch mode power supply has the advantages of high efficiency, small size, and good output stability, there is a very significant problem with electromagnetic interference during the operation of the switch mode power supply. The electromagnetic interference of the switch mode power supply comes mainly from sources of external interference, the noise of switching elements turning off and on, the noise of the rectifier diode's current direction, and noise generated by capacitors, inductors, wires, etc. These noise signals are conducted along the electronic circuits and radiated to the electronic appliances, causing electromagnetic interference.

In electronic products, electromagnetic compatibility (EMC) and electromagnetic interference (EMI) must both comply with relevant regulations. However, the most common methods of suppressing electromagnetic interference have the following disadvantages: additional noise surges due to added capacitors with large capacitance values, complex designs, and an increase in the turns of the transformer or inductor.

### BRIEF SUMMARY OF THE INVENTION

Accordingly, the present invention proposes a novel transformer, which uses a compensation winding in conjunction with a capacitor with a small capacitance value in the transformer, so as to flexibly increase the adjustment capability for the suppression of electromagnetic interference, and achieve the effect of significantly suppressing electromagnetic noise. In addition, a power converter using the transformer is also proposed.

One embodiment of the present invention provides a transformer, which comprises a primary winding, a secondary winding, an external capacitor, and a cancellation winding. The primary winding has a first end and a second end, wherein the first end is coupled to a first potential point of a primary side circuit, and the second end is coupled to a second potential point of the primary side circuit. The secondary winding has a third end and a fourth end, wherein the third end is coupled to a third potential point of a secondary side circuit, and the fourth end is coupled to a fourth potential point of the secondary side circuit. The compensation winding has a fifth end and a sixth end, wherein the fifth end is coupled to the first potential point or the third potential point, and the sixth end is coupled to the other of the first potential point or the third potential point through the external capacitor. In addition, the compensation winding is arranged between the primary winding and the secondary winding, and the voltage potentials induced by the compensation winding and the secondary winding are equal.

According to some aspects of the aforementioned embodiment, the first potential point and the third potential point are the static potential points of the primary side circuit and the secondary side circuit, respectively. The dynamic potential point of the primary side circuit is the second potential point, or the dynamic potential point of the secondary side circuit is the fourth potential point, or both.

According to some aspects of the aforementioned embodiments, the primary winding, the secondary winding and the compensation winding are formed together on a printed circuit board. Alternatively, only the secondary winding and the compensation winding are formed on the printed circuit board, and the primary winding is arranged above and adjacent to the printed circuit board.

According to some aspects of the aforementioned embodiments, the primary winding includes one or more first winding layers, the secondary winding includes one or more second winding layers, and the compensation winding includes one or more third winding layers. A third winding layer is inserted between any two adjacent first winding layers and the second winding layers.

According to some aspects of the aforementioned embodiments, the compensation winding has the same turns as the secondary winding.

According to some aspects of the aforementioned embodiments, the transformer further includes an auxiliary winding connected in series with the compensation winding. In addition, the auxiliary winding does not overlap the compensation winding, the primary winding and the secondary winding. In addition, the auxiliary winding and the secondary winding may be arranged adjacent to each other and may be substantially on the same plane.

According to some aspects of the aforementioned embodiments, the transformer further includes a tertiary winding that includes the compensation winding and the auxiliary winding. If there are no turns in the auxiliary winding, the tertiary winding is composed of the compensation winding alone.

According to some aspects of the aforementioned embodiments, the secondary side circuit is coupled to a first output circuit, and the tertiary winding is coupled to a second output circuit. In addition, the auxiliary winding is connected to the sixth end of the compensation winding.

According to some aspects of the aforementioned embodiments, the fifth end of the compensation winding is directly connected to the first potential point, and the sixth end of the compensation winding is connected to the third potential point through the external capacitor.

Another embodiment of the present invention provides a power converter, including a primary side circuit, a secondary side circuit, and a transformer (the type of which may vary) according to the aforementioned embodiments. The transformer is arranged between the primary side circuit and the secondary side circuit.

### BRIEF DESCRIPTION OF THE DRAWINGS

The present invention can be more fully understood by reading the subsequent detailed description and examples with references made to the accompanying drawings, wherein:

FIG. 1 is a schematic circuit diagram of a power converter 10.

FIG. 2 is a circuit diagram showing a small signal model of the power converter 10.

FIG. 3 is a circuit diagram showing a small signal model of a power converter 30 with a cancellation winding and an external capacitor.

FIG. 4 is a circuit diagram showing a small signal model of a power converter 40 with a cancellation winding but without an external capacitor.

FIG. 5 is a circuit diagram showing a small signal model circuit diagram of a power converter 50 with a shielded winding.

FIG. 6 is a circuit diagram showing a power converter 60 according to an embodiment of the present invention.

FIG. 7A is a circuit diagram showing a small signal model of the power converter 60.

FIG. 7B is a further simplified diagram of the power converter 60 of FIG. 7A, to illustrate the configuration of a transformer 63 in the present embodiment.

FIG. 8 shows winding configuration I and winding configuration II of the transformer 63 of the present embodiment.

FIG. 9 shows a configuration example in which the primary winding w₁, the secondary winding w₂, and the compensation winding w_{c} of the present embodiment all include a single winding.

FIG. 10 shows a configuration example in which the primary winding w1 includes two first winding layers (w₁₁, w₁₂), the secondary winding w₂ includes two second winding layers (w₂₁, w₂₂), and the compensation winding w_{c} includes two compensation winding layers (w_{c1}, w_{c2}) in the present embodiment.

FIG. 11 is the verification results showing the common mode noise suppression of the power converter of the present invention and other previous power converters.

### DETAILED DESCRIPTION OF THE INVENTION

In order to make the above-mentioned objects, features and advantages of the present invention more clearly understood, the following is a detailed description of the preferred embodiments in conjunction with the accompanying drawings.

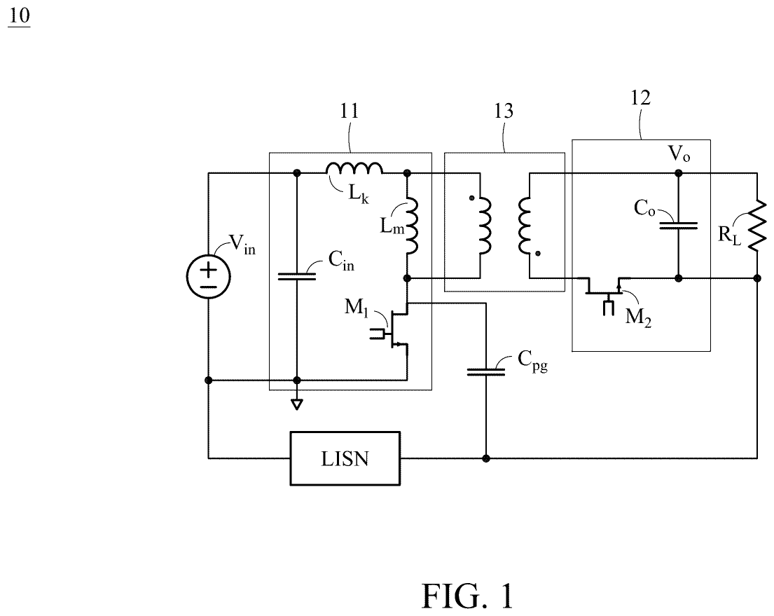

FIG. 1 is a schematic circuit diagram of a power converter 10. In FIG. 1, the power converter 10 is, for example, a switch mode power supply (SMPS) having a flyback architecture. However, the power converter of the present invention is not limited to this.

The power converter 10 includes a primary side circuit 11, a secondary side circuit 12, and a transformer 13. The primary side circuit 11 includes, for example but not limited to, an input capacitor Cᵢₙ, an inductor Lₖ, a magnetizing inductor Lₘ, and a first switching element M₁. The secondary side circuit 12 includes, for example but not limited to, a second switching element M₂ and an output capacitor Cₒ. The first switch element M₁ and the second switch element M₂ are, for example but not limited to, MOS transistors.

The transformer 13 is connected between the primary side circuit 11 and the secondary side circuit 12. The power converter 10 receives a DC voltage source Vᵢₙ, and outputs a voltage Vₒ to a load RL through the operation of the primary side circuit 11, the transformer 13, and a secondary side circuit 12. The operation of the flyback switch mode power supply is well known, and therefore its operating principle will not be described in detail here.

In the power converter 10, the first switch element M1 and the second switch element M₂ perform the operations of turning on and turning off, therefore causing noise is introduced into the circuit. The noise of the power converter 10 includes, for example, differential mode noise and common mode noise. The common mode noise mainly includes the noise relative to a reference ground generated by the interaction between various components in the power converter 10. Here, the LISN (Line Impedance Stabilization Network) in FIG. 1 can be used to measure the common mode noise.

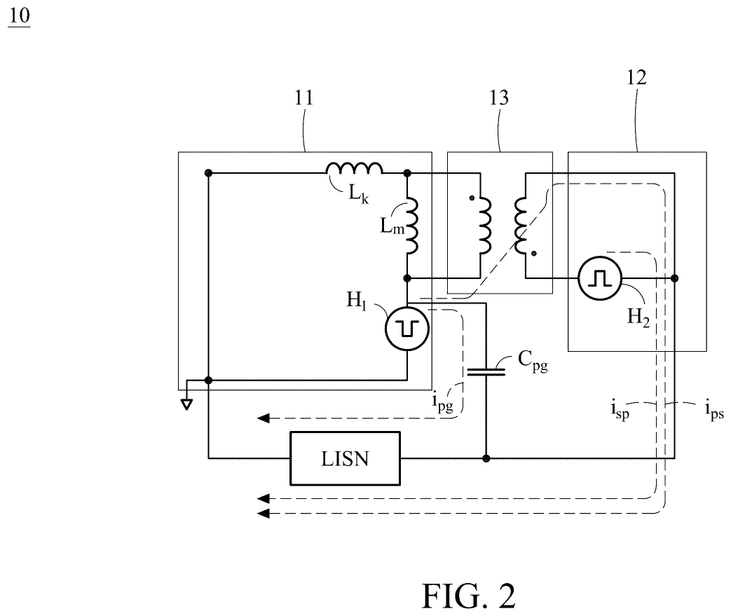

FIG. 2 is a circuit diagram showing a small signal model of the power converter 10. Since the small signal model of the power converter 10 is shown in FIG. 2, the DC voltage source Vᵢₙ in FIG. 1 is considered to be short-circuited in FIG. 2. In addition, the interference sources caused by the first switch element M₁ and the second switch element M₂ can be represented by symbols H₁ and H₂, respectively. The interference sources indicated by H₁ and H₂ correspond to the dynamic potential points of the primary side circuit 11 and the secondary side circuit 12, respectively.

In FIG. 2, C_{pg} is an interlayer capacitor between the first switching element M₁ and, for example, a heat sink (not shown). Cₚₛ (not shown) is an interlayer capacitor between the primary winding and the secondary winding of the transformer 13. Cₛₚ (not shown) is an interlayer capacitor between the secondary winding and the primary winding of the transformer 13. It should be noted that due to the switching of the first switch element M₁, the noise current i_{pg} flows through the capacitor C_{pg}, and the noise current iₚₛ flows from the primary side circuit 11 to the secondary side circuit 12 via the capacitor Cₚₛ; and due to the switching of the second switch element M₂, the noise current iₛₚ flows from the secondary side circuit 12 to the primary side circuit 11 via the capacitor Cₛₚ. Therefore, from the noise currents i_{pg}, ᵢₚₛ, and isp shown in FIG. 2, it can be seen that the common mode noise (current) i_{CM} measured by the LISN is equal to i_{pg}+iₚₛ+Iₛₚ. To be specific, the interlayer capacitor is not a physically existing capacitor, but a capacitance phenomenon caused by mutual induction between two adjacent conductors. This phenomenon is more obvious under high frequency conditions. For the convenience of analysis, the interlayer capacitor is represented by equivalent capacitance.

There are various methods that can be used to reduce the common mode noise I_{CM}. One of them is to use cancellation windings to reduce the common mode noise.

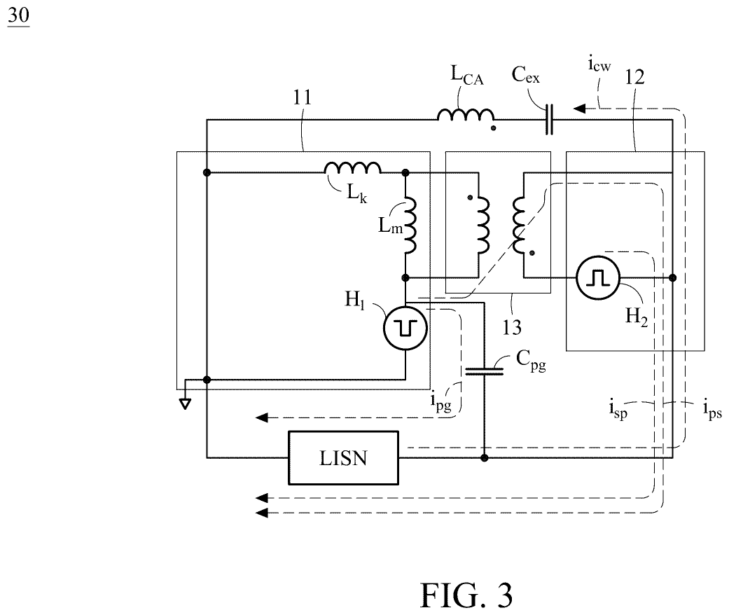

FIG. 3 is a circuit diagram showing the small signal model of a power converter 30 having a cancellation winding L_{CA} and an external capacitor Cₑₓ.

Compared to FIG. 2, the power converter 30 of FIG. 3 further includes a cancellation winding L_{CA} and an external capacitor Cₑₓ, and the other parts are the same as those of FIG. 2. One end of the cancellation winding L_{CA} is connected in series with one end of the external capacitor Cₑₓ; the other end of the cancellation winding L_{CA} is connected to the static potential point of the primary circuit 11, and the other end of the external capacitor Cₑₓ is connected to the static potential point of the secondary side circuit 62.

Here, the static potential point of the primary side circuit 11 is the reference ground of the primary side circuit 11 (under the small signal model), and the static potential point of the secondary side circuit 12 is the reference ground of the secondary side circuit 12 (under the small signal model). The turn of the cancellation winding L_{CA} is 1. For real position, the cancellation winding L_{CA} is not limited to be provided between the primary winding and the secondary winding of the transformer 13.

Referring to FIG. 3, by adding the cancellation winding L_{CA} and the external capacitor Cₑₓ, a cancellation current i_{cw} equal to

$${C}_{ex} \cdot \frac{dv}{dt}$$

can be added. The cancellation current icw is proportional to the external capacitor (i.e., capacitance) Cₑₓ, and dv/dt, is proportional to the turns of the cancellation winding L_{CA}. Therefore, the magnitude of the cancellation current icw can be controlled by adjusting the external capacitor Cₑₓ. The common mode noise measured by the LISN in FIG. 3 is represented as the formula:

$${i}_{CM} = {i}_{pg} + {i}_{ps} + {i}_{sp} - {i}_{cw} .$$

Therefore, ideally, if the cancellation current icw can be adjusted to equal i_{pg}+iₚₛ+iₛₚ−i_{cw}, the common mode noise i_{CM} will be zero. Consequently, this method can control the cancellation current i_{cw} by adjusting the external capacitor Cₑₓ to reduce the common mode noise i_{CM}.

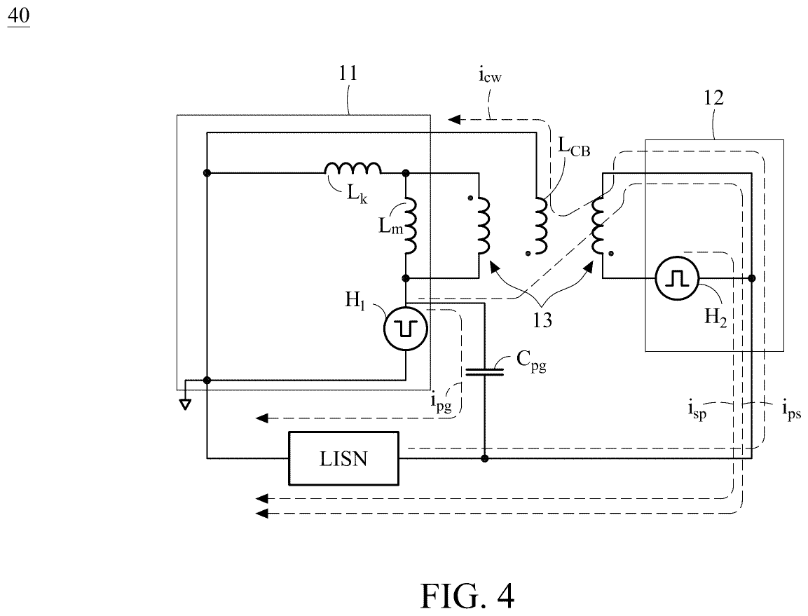

FIG. 4 is a circuit diagram showing a small signal model of a power converter 40 with a cancellation winding but without an external capacitor.

Compared with FIG. 3, the power converter 40 of FIG. 4 does not have the external capacitor Cₑₓ. One end of the cancellation winding L_{CB} is connected to the static potential point of the primary circuit 11, and the other end of the cancellation winding L_{CB} is in a floating state.

In addition, the turns of the cancellation winding L_{CB} in FIG. 4 is multiple turns (greater than or equal to 2 turns), and is limited to be physically arranged between the primary winding and the secondary winding of the transformer 13. The other parts of the power converter 40 are the same as that of FIG. 3. Furthermore, the potential induced by the cancellation winding LCB is not equal to the potential induced by the secondary winding of the transformer 13.

Referring to FIG. 4, by adding a compensation winding LCB and floating the other end of the compensation winding L_{CB}, a compensation current icw equal to

$${i}_{CM} = {i}_{pg} + {i}_{ps} + {i}_{sp} - {i}_{cw} .$$

can be added. Here, C_{cs} represents an interlayer capacitor (not shown) between the cancellation winding L_{CB} and the secondary winding. In addition, the interlayer capacitor (i.e., capacitance) C_{cs} is proportional to the cancellation current icw, and the dv/dt, is proportional to the turns of the cancellation winding L_{CB}. Therefore, the magnitude of the cancellation current icw can be controlled by adjusting the cancellation winding L_{CB}. The common mode noise measured by the LISN in FIG. 4 is represented by the formula:

$${C}_{cs} \cdot \frac{dv}{dt}$$

Therefore, ideally, if the cancellation current i_{cw} can be adjusted to equal i_{pg}+iₚₛ+iₛₚ−i_{cw}, then the common mode noise i_{CM} becomes zero.

In FIG. 4, the power converter 40 does not use the external capacitor Cₑₓ. Although the cancellation current i_{cw} can be controlled by adjusting the turns of the cancellation winding L_{CB}, it is necessary to accurately know the interlayer capacitance value Ccs between the secondary winding of the transformer 13 and the cancellation winding L_{CB}, and the desired cancellation current i_{cw}, so as to properly adjust the turns of the cancellation winding. In addition, adjusting the turns also requires changing the structure of the cancellation winding. Therefore, it is difficult to perform fine tuning in practice and is not easy to implement in practice.

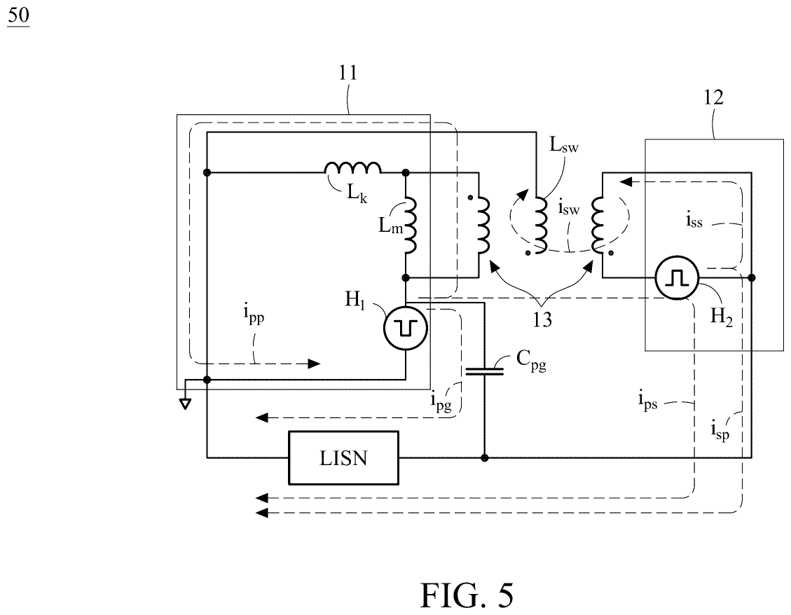

FIG. 5 is a circuit diagram showing a small signal model circuit diagram of a power converter 50 with a shielded winding.

The main difference between the shielding winding L_{SW} of FIG. 5 and the cancellation winding L_{CB} of FIG. 4 is that the potential induced by the shielding winding L_{SW} is equal to the potential induced by the secondary winding of the transformer 13, while the potential induced by the cancellation winding L_{CB} is not equal to the potential induced by the secondary winding of the transformer 13. The other parts of the power converter 50 in FIG. 5 are the same as that of FIG. 4.

Referring to the currents shown in FIG. 4, it can be seen that the noise current iₚₛ on the primary side of the transformer 13 and the noise current isp on the secondary side of the transformer flow through the LISN. The cancellation current i_{cw} will flow through the LISN to reduce the noise currents.

However, referring to the currents shown in FIG. 5, since the induced voltage potential of the shield winding L_{SW} is equal to the induced voltage potential of the secondary winding of the transformer, the most current iₚₚ of the noise current (interference source H₁) in the primary side circuit 11 will not flow through the LISN, and only a small part of the current iₚₛ will flow through the LISN. Moreover, the most current iₛₛ of the noise current (interference source H₂) in the secondary side circuit 12 will not flow through the LISN, only a small part of the current isp will flow through the LISN. Through making the induced voltage potential of the shield winding equal to the induced voltage potential of the secondary winding of the transformer 13, the common mode noise is reduced. The shield current i_{sw} flows between the shield winding L_{SW} and the secondary winding.

When using a cancellation winding and an external capacitor (as shown in FIG. 3) to reduce the common mode noise, most part of the common mode noise can be cancelled by the cancellation current icw flowing through the LISN. However, the use of the external capacitors may cause noise spike or surge in the intermediate frequency region and high frequency region, and may amplify the leakage current. If the cancellation winding is used without the external capacitor (as shown in FIG. 4) to reduce the common mode noise, there are practical difficulties for implementation. If the shielded winding (as shown in FIG. 5) is used to reduce the common mode noise, most portion of the noise currents iₚₚ and iₛₛ will not flow through the LISN, but a small portion of the noise currents iₚₛ and isp will still flow through the LISN.

In view of this, the applicant proposes a novel winding connection configuration that can more effectively reduce common the mode noise, and is easier to implement in power converters and transformers. Embodiments of the present invention will be described below with reference to the drawings.

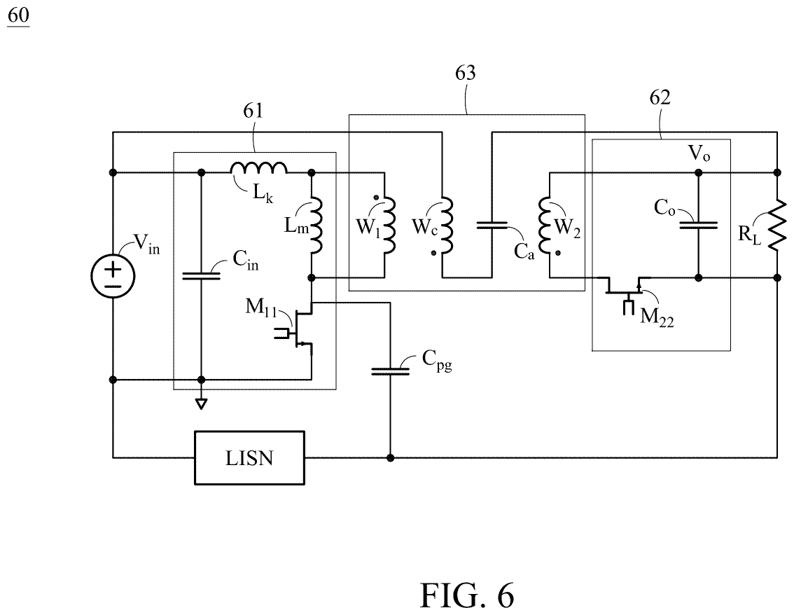

FIG. 6 is a circuit diagram showing a power converter 60 according to an embodiment of the present invention. In FIG. 6, the power converter 60 includes, for example, a switch mode power supply (SMPS) having a flyback architecture, but is not limited thereto.

The power converter 60 includes a primary side circuit 61, a secondary side circuit 62, and a transformer 63. The primary side circuit 61 includes, for example but not limited to, an input capacitor Cᵢₙ, an inductor Lₖ, a magnetizing inductor Lₘ, and a switching element M₁₁. The secondary side circuit 62 includes, for example but not limited to, a switching element M₂₂ and an output capacitor Cₒ. The switching element M₁₁ and the switching element M₂₂ may be, for example but not limited to, MOS transistors.

The transformer 63 is connected between the primary side circuit 61 and the secondary side circuit 62. The power converter 60 receives a DC voltage source Vᵢₙ, and outputs a voltage Vₒ to a load R_{L} through the operation of the primary side circuit 61, the transformer 63, and the secondary side circuit 62. Since the operation of the switch mode power supply with flyback architecture is well known, its operating principle will not be described in detail here. In addition, the LISN (Line Impedance Stabilization Network) in FIG. 6 is used to measure the common mode noise.

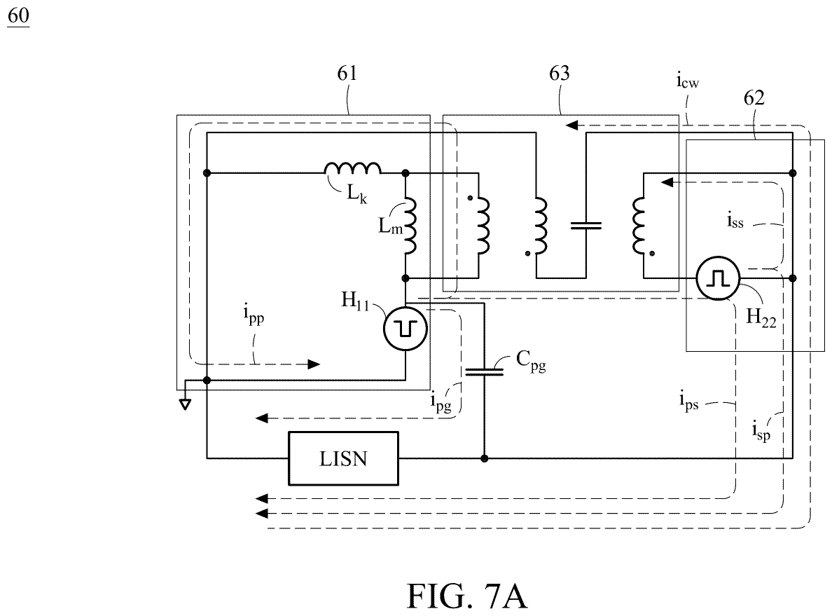

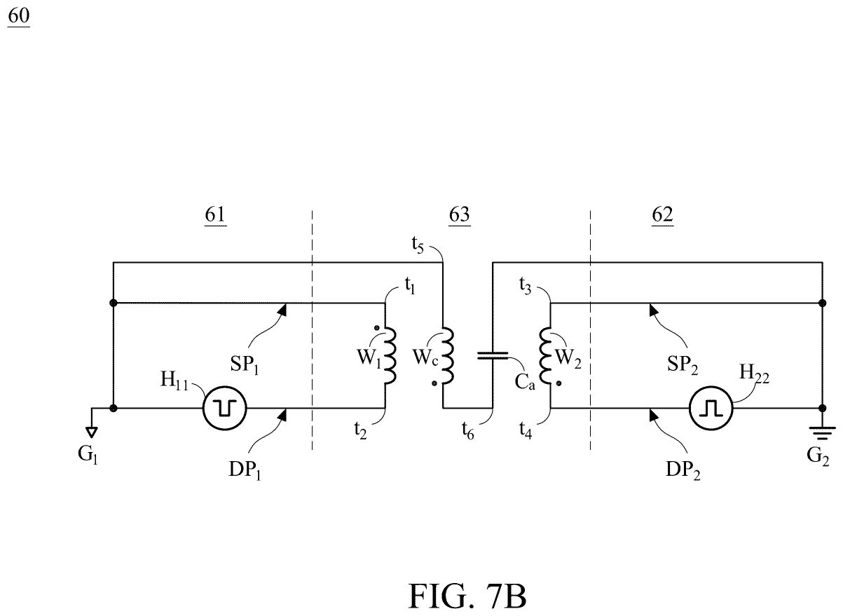

FIG. 7A is a circuit diagram showing a small signal model of the power converter 60. Since FIG. 7A shows the power converter 60 under the small signal model, the DC voltage source Vᵢₙ in FIG. 6 is considered to be short-circuited. In addition, the interference sources caused by the switch element M₁₁ and the switch element M₂₂ are represented by symbols H₁₁ and H₂₂ respectively.

It can be seen from the currents marked in FIG. 7A that the noise currents i_{pg}, iₚₛ, and iₛₚ will flow through the LISN, and the cancellation current i_{cw} will further cancel part of the noise currents (i_{pg}, iₛₚ, and iₚₛ). In addition, since most of the noise current iₚₚ of the interference source H₁₁ will not flow through the LISN, and most of the noise current iₛₛ of the interference source H₂₂ will not flow through the LISN, and thus the common mode noise (common mode current) measured by the LISN can be significantly reduced.

FIG. 7B is a further simplified diagram of the power converter 60 of FIG. 7A, to illustrate the configuration of the transformer 63 in the present embodiment. The interference sources indicated by H₁₁ and H₂₂ respectively coupled to the dynamic potential points of the primary side circuit 61 and the secondary side circuit 62. Below, under the small signal model, the dynamic potential points of the primary side circuit 61 and the secondary side circuit 62 are respectively marked as DP₁ and DP₂. In addition, the static potential point of the primary side circuit 61 is marked as SP₁, and is connected to the reference ground G₁. The static potential point of the secondary side circuit 62 is marked as SP₂, and is connected to the reference ground G₂, which indicates SP₂.

Referring to FIG. 7B, the transformer 63 includes a primary winding w₁, a secondary winding w₂, a compensation winding w_{c}, and an external capacitor Cₐ. The primary winding w₁ has a first end t₁ and a second end t₂. The first end t₁ is coupled to a first potential point of the primary side circuit 61, and the second end t₂ is coupled to a second potential point of the primary side circuit 61. The secondary winding w₂ has a third end t₃ and a fourth end t₄. The third end t₃ is coupled to the third potential point of the secondary side circuit 62, and the fourth end t₄ is coupled to the fourth potential point of the secondary side circuit 62.

The compensation winding w_{c} has a fifth end t₅ and a sixth end t₆. Of the fifth end t₅ and the sixth end t₆, one is coupled to the first potential point and the other is coupled to the third potential point through an external capacitor Cₐ. It should be noted that the compensation winding w_{c} is arranged between the primary winding w₁ and the secondary winding w₂, and the potentials induced by the compensation winding w_{c} and the secondary winding w₂ are equal. In this embodiment, the turns of the compensation winding are equal to the turns of the secondary winding, so that the potentials induced by the compensation winding w_{c} and the secondary winding w₂ are equal.

In this embodiment, the first potential point and the third potential point are respectively the static potential point SP₁ of the primary side circuit 61 and the static potential point SP₂ of the secondary side circuit 62. Moreover, at least one of the second potential point and the fourth potential point is the dynamic potential point DP₁ of the primary side circuit 61 or the dynamic potential point DP₂ of the secondary side circuit 62.

It should be noted that the dynamic potential point and the static potential point of the primary side circuit 61 and the secondary side circuit 62 will change with the different arranged positions of the switching elements M₁₁ and M₂₂. Therefore, the structure shown in FIG. 7B is only an example and is not intended to limit the present invention. That is, according to the invention, regardless of the change in the arranged positions of the switching elements, it is sufficient as long as the compensation winding wc and the external capacitor Cₐ are connected in series between the static potential point of the primary side circuit and the static potential point of the secondary side circuit.

The following further describes the configuration of the primary winding w₁, the secondary winding w₂, and the compensation winding w_{c}, in the transformer 63 of this embodiment.

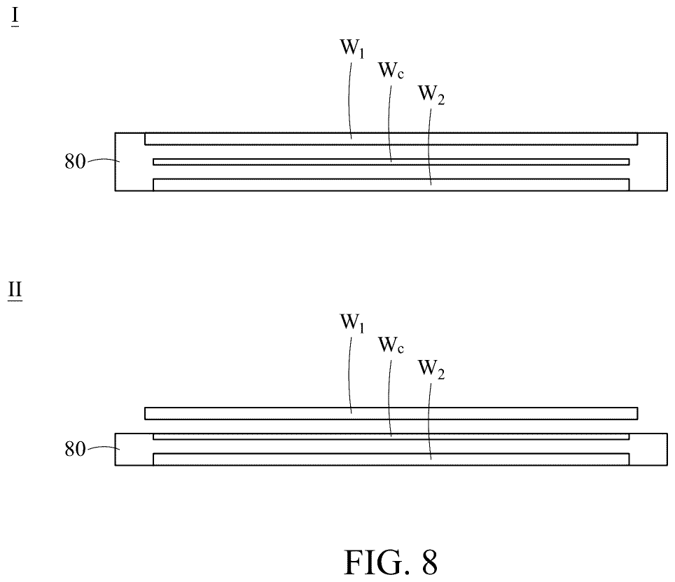

FIG. 8 shows the detailed winding configuration I and winding configuration II of the transformer 63 of this embodiment. The primary winding w1, the secondary winding W₂, and the compensation winding w_{c} of the transformer 63 may be formed on the printed circuit board 80. For example, as shown in the configuration I, the primary winding w₁ and the secondary winding w₂ are respectively formed on the first surface (front surface) and the second surface (back surface) of the printed circuit board 80, and the compensation winding w_{c} is formed in the printed circuit board 80 and is located between the primary winding w₁ and the secondary winding w₂.

Alternatively, for example, as shown in configuration II, only the compensation winding w_{c} and the secondary winding w₂ are formed on the first surface (front surface) and the second surface (back surface) of the printed circuit board 82, respectively, and the primary winding w₁ is above and adjacent to the printed circuit board 82 and arranged above the compensation winding w_{c}. In this case, the configuration of the primary winding w₁ has no particularly limitation, and can be composed of various conductive wires such as a single-core wire and a Litz wire.

In addition, the primary winding w₁ can include a single winding, or composed of a plurality of (x) first winding layers w₁₁˜w₁ₓ connected in series. Similarly, the secondary winding w2 may include a single winding, or may include a plurality (y) of second winding layers w₂₁ to w_{2y} connected in series. Moreover, the compensation winding w_{c} may include a single winding, or include a plurality (z) of compensation winding layers w_{c1}˜w_{cz} connected in series. Wherein, x, y, and z are integers greater than 1. When the primary winding, the secondary winding, and the compensation winding have multiple winding layers, the overall turns of any winding is the sum of the turns of each winding layer. It should be noted that one compensation winding layer may be arranged (inserted) between any two adjacent winding layers, with one being a first winding layer and the other being a second winding layer.

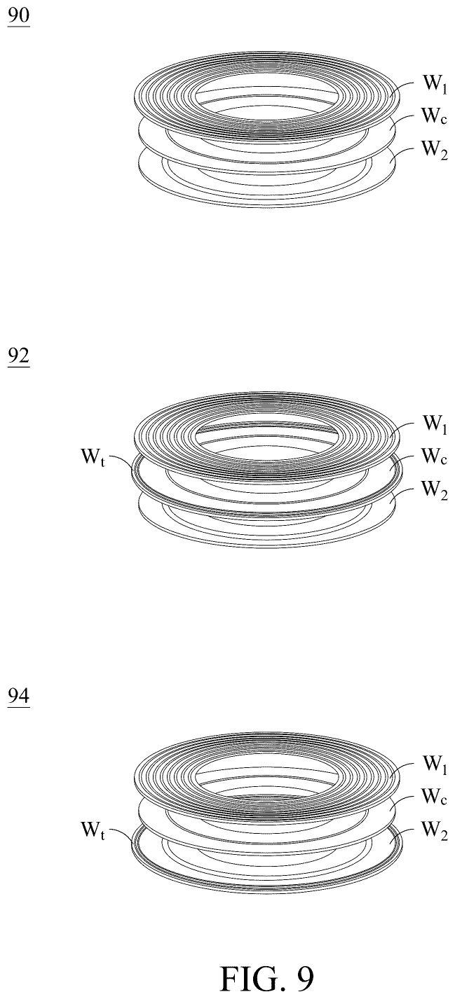

FIG. 9 shows a configuration example in which the primary winding w₁, the secondary winding w₂, and the compensation winding w_{c} of the present embodiment all include a single winding. In the configuration 90 of FIG. 9, a compensation winding wc is inserted between the primary winding w1 and the secondary winding w₂. In addition, the compensation winding w_{c} may be further connected in series with an auxiliary winding wₜ, and the location of the auxiliary winding wₜ is not particularly limited. For example, in configuration 92, the auxiliary winding wₜ (for example, 2 turns) may be arranged adjacent to the compensation winding w_{c}. Alternatively, in configuration 94, the auxiliary winding wₜ (for example, 2 turns) may be arranged adjacent to the secondary winding w₂.

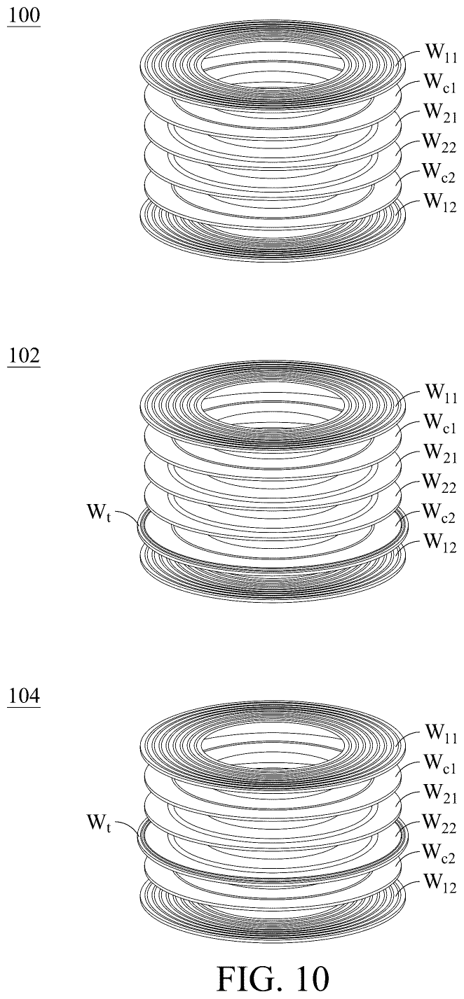

FIG. 10 shows a configuration example in which the primary winding w₁ includes two first winding layers (w₁₁, w₁₂), the secondary winding w₂ includes two second winding layers (w₂₁, w₂₂), and the compensation winding wc includes two compensation winding layers (w_{c1}, w_{c2}) in the present embodiment.

In the configuration 100 of FIG. 10, the compensation winding layer w_{c1} is inserted between the adjacent first winding layer w11 and the second winding layer w₂₁, and the compensation winding layer w_{c2} is inserted between the adjacent second winding layer w₂₂ and the first winding layer w₁₂.

In the configurations 102 and 104 of FIG. 10, the configurations of the first winding layers (w₁₁, w₁₂), the second winding layers (w₂₁, w₂₂), and the compensation winding layers (w_{c1}, w_{c2}) are the same as that of the configuration 100. In the configuration 102, an auxiliary winding wₜ (for example, 2 turns) is further arranged near the secondary winding layer w₂₂. In the configuration 104, another auxiliary winding wₜ (for example, 2 turns) is provided near the compensation winding w_{c2}.

The auxiliary winding wₜ is arranged adjacent to the secondary winding (layers) or the compensation winding (layers) and is substantially on the same plane.

It should be noted that the auxiliary winding wₜ must not overlap with any of the compensation winding (layers), the primary winding (layers), and the secondary winding (layer). In this way, the interlayer capacitance between the auxiliary winding wₜ and the primary winding (layer), and the interlay capacitance of the secondary winding (layer) can be reduced to a minimum, so as to present the generation of the common mode current, and avoid increasing the common mode noise. In some embodiments, an external capacitor may also be connected between the compensation winding and the auxiliary winding, and the external capacitor is not overlapped by any of the primary winding (layers) and the secondary winding (layers).

The transformer 63 may further include a tertiary winding w₃ (not shown in FIG. 9), which includes the compensation winding w_{c} and the auxiliary winding wt. The tertiary winding w₃ can be formed by the compensation winding w_{c} alone, that is, there are no turns in the auxiliary winding.

The secondary side circuit 62 of the power converter 60 is coupled to a first output circuit (not shown) to provide a first output voltage. The tertiary winding w₃ of the transformer 63 may also be coupled to a second output circuit (not shown) to provide a second output voltage. Here, the turns of the auxiliary winding wₜ in the tertiary winding w₃ is determined by the second output voltage to be provided in actual application. The more turns of the auxiliary winding there are, the higher the second output voltage will be.

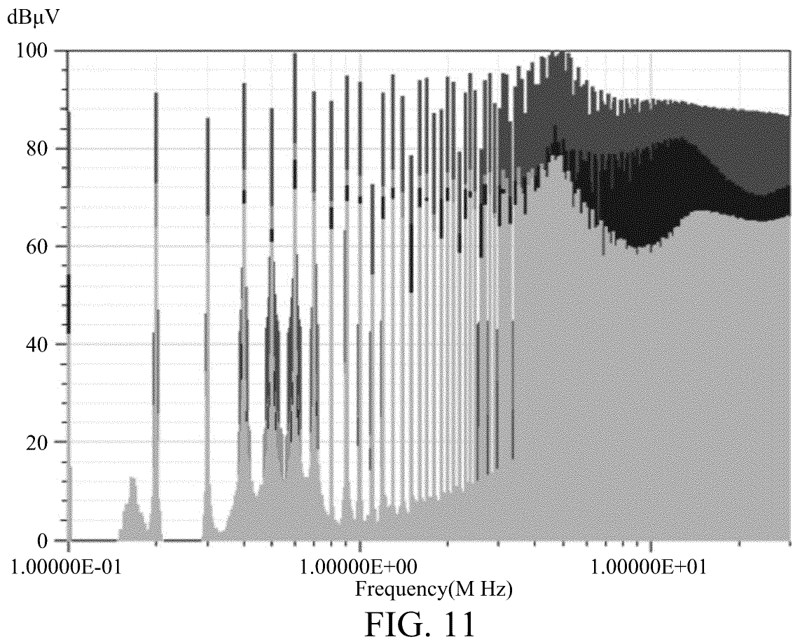

FIG. 11 shows the verification results of the power converter 60 of the present invention and the other power converters 20, 50, 30 mentioned above in suppressing common mode noise.

The power converters shown in FIG. 2, FIG. 5, FIG. 3, and FIG. 7A are used to test their common-mode noise suppression capabilities.

Please refer to FIG. 11 for the explanation below. The graph marked in “Red” are for experiment case 1, which uses the structure of FIG. 2, without any shielding windings or cancellation windings. The graph marked in “Orange” is for experimental case 2, which uses the structure of FIG. 5, and the shielding winding has 3 turns. The graph marked in “Dark Blue” are for Experiment Case 3, which uses the structure of FIG. 3, and with the cancellation winding having 1 turn, and the capacitance value of the external capacitor Cₑₓ being 480 pF. The graph marked in “Light Blue” are for experiment case 4, which uses the structure of FIG. 7A, with the compensation winding having 3 turns, and the capacitance value of the external capacitor Cₑₓ being 26 pF.

From the verification results in FIG. 11, it can be seen that, for example, at the reference frequency of 100 kHz, the common mode noise measured in case 1 to case 4 is 87.5, 71.4, 54.6, and 42.2 dBμv, respectively, and that the common mode noise suppression capability of the present invention (case 4) is significantly better than that of other structures (cases 1˜3). Furthermore, the capacitance value of the external capacitor Cₑₓ required by the present invention, 26 pF, is also much smaller than the capacitance value of 480 pF in case 3. In addition, using the structure of FIG. 7A of the present invention (case 4), there is no noise surge or spike in the intermediate frequency and the high frequency.

Although the present invention is disclosed as above with preferred embodiments, it is not intended to limit the scope of the present invention. Any person with ordinary skill in the technical field may make some changes and modifications without departing from the spirit and scope of the present invention. Therefore. the protection scope of the present invention shall be based on the scope defined by the attached patent claims.

What is claimed is:

1. A transformer, comprising:
a primary winding having a first end and a second end, wherein the first end is coupled to a first potential point of a primary side circuit, and the second end is coupled to a second potential point of the primary side circuit;
a secondary winding having a third end and a fourth end, wherein the third end is coupled to a third potential point of a secondary side circuit, and the fourth end is coupled to a fourth potential point of the secondary side circuit;
an external capacitor; and
a compensation winding having a fifth end and a sixth end, wherein the fifth end is coupled to either the first potential point or the third potential point, and the sixth end is coupled to the other of the first potential point and the third potential point through the external capacitor;
wherein the compensation winding is arranged between the primary winding and the secondary winding, and the voltage potentials induced by the compensation winding and the secondary winding are equal.

2. The transformer as claimed in claim 1, wherein the first potential point and the third potential point are respective static potential points of the primary side circuit and the secondary side circuit; and
the second potential point is a dynamic potential point of the primary side circuit or the fourth potential point is a dynamic potential point of the secondary side circuit, or both.

3. The transformer as claimed in claim 2, wherein the primary winding, the secondary winding and the compensation winding are formed in a printed circuit board; or
the secondary winding and the compensation winding are formed in the printed circuit board but the primary winding is formed adjacent to the printed circuit board.

4. The transformer as claimed in claim 2, wherein the primary winding includes one or more first winding layers, the secondary winding includes one or more second winding layers, and the compensation winding includes one or more third winding layers; and
at least one of the third winding layers is inserted between any two adjacent winding layers, with one being one said first winding layer and the other being one said second winding layer.

5. The transformer as claimed in claim 2, wherein turns of the compensation winding is the same as that of the secondary winding.

6. The transformer as claimed in claim 2, further comprising:
an auxiliary winding which is connected with a compensation winding in series.

7. The transformer as claimed in claim 6, wherein the auxiliary winding do not overlap the compensation winding, the primary winding, and the secondary winding.

8. The transformer as claimed in claim 7, wherein the auxiliary winding and the secondary winding are arranged adjacent to each other, and are substantially on the same plane.

9. The transformer as claimed in claim 6, further comprising:
a tertiary winding constituted by the compensation winding and the auxiliary winding;
wherein the tertiary winding is constituted by the compensation winding alone when there are no turns in the auxiliary winding.

10. The transformer as claimed in claim 9, wherein there is at least one turn of the auxiliary winding.

11. The transformer as claimed in claim 9, wherein the secondary side circuit is coupled to a first output circuit, and the tertiary winding is coupled to a second output circuit.

12. The transformer as claimed in claim 10, wherein the secondary side circuit is coupled to a first output circuit, and the tertiary winding is coupled to a second output circuit.

13. The transformer as claimed in claim 6, wherein the auxiliary winding is connected to the sixth end of the compensation winding.

14. The transformer as claimed in claim 2, wherein the fifth end of the compensation winding is directly connected to the first potential point, and the sixth end of the compensation winding is connected to the third potential point through the external capacitor.

15. A power converter comprising:
a primary side circuit;
a secondary side circuit; and
a transformer, arranged between the primary side circuit and the secondary side circuit;
wherein the transformer includes:
a primary winding having a first end and a second end, wherein the first end is coupled to a first potential point of the primary side circuit, and the second end is coupled to a second potential point of the primary side circuit;
a secondary winding having a third end and a fourth end, wherein the third end is coupled to a third potential point of the secondary side circuit, and the fourth end is coupled to a fourth potential point of the secondary side circuit;
an external capacitor; and
a compensation winding having a fifth end and a sixth end, wherein the fifth end is coupled to either the first potential point or the third potential point, and the sixth end is coupled to the other of the first potential point or the third potential point through the external capacitor;
wherein the compensation winding is arranged between the primary winding and the secondary winding, and the voltage potentials induced by the compensation winding and the secondary winding are equal.
